(19) United States
(12) Patent Application Publication
(10) Pub. No.: US 2008/0289116 A1
(43) Pub. Date: Nov. 27, 2008

(54) Fabric treatment compositions, their manufacture and use

(75) Inventors: Iain Sunil Young, Sharnbrook (GB); Shiping Zhu, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco Inc, d/b/a UNILEVER

(21) Appl. No.: 12/072,463

(22) Filed: Feb. 26, 2008

(30) Foreign Application Priority Data
Feb. 28, 2007 (EP) EP07103239

(51) Int. Cl. C11D 3/26

(52) U.S. Cl. 8/137; 510/515; 510/330

(57) ABSTRACT

A method of conditioning fabrics, the method comprising dosing a solid fabric treatment composition comprising:

(a) one or more quaternary ammonium fabric softening materials; and
(b) a fatty component selected from fatty acids, fatty alcohols and mixtures thereof;
into a wash cycle of an automatic washing machine, allowing the wash cycle to be completed and then performing a rinse cycle in the washing machine. The composition may also be dosed into the rinse cycle direct.

The composition may be formed as a melt which is cooled. The composition may contain less than 5 wt % of water. The composition may comprise one or more of anionic surfactants, non-polymeric water soluble builders and water soluble non-builder inorganic salts.

### FIELD OF THE INVENTION

The present invention relates to a fabric treatment composition. The invention particularly relates to fabric conditioning compositions for imparting softness and/or other conditioning benefits to a fabric.

### BACKGROUND OF THE INVENTION

It is well known to dose fabric treatment compositions in the rinse cycle of a washing machine to impart one or more benefits such as fabric softness, anti-crease, ease of ironing benefit, perfume delivery and the like. The imparting of such a benefit to a fabric is referred to herein as “conditioning”. Such compositions typically contain cationic quarternary ammonium fabric softening surfactants. They may also include materials such as silicone oils and perfume.

These conventional compositions are typically viscous liquid components which are typically dosed direct into a washing machine or into a separate compartment, e.g. a part of a dispenser drawer through which the rinsed water is channelled.

On the other hand, the majority of fabric washing compositions are dosed in solid form, either as powders, or, as has become more common in recent times, tablets. Typically, powders are either dosed into a fabric washing powder compartment in the dispenser drawer or in a ball or other similar dosing device, directly into the drum. Tablets are also dosed directly into the drum, e.g. inside a net or bag provided for the purpose.

The dosing of fabric softening or similar products in liquid form is rather messy and it is also inconvenient to dose the product separately from the fabric wash in composition. It would be very desirable if a fabric softening or other benefit agent could be delivered as a solid composition. It would also be extremely desirable if the softening or other composition could be dosed as part of, or simultaneously with, the fabric washing product.

Previously, it has been known to utilise certain fabric softening clays as a solid component of a fabric wash composition. However, fabric softening clays are not as effective as quarternary ammonium fabric softening agents in their ability to impart softness. Moreover, these fabric softening clays are used to exert their action as softening-in-the-wash products. That is to say, they are active as ingredients in fabric wash compositions and exert their softening effect during the wash cycle. They are not active during the rinse cycle and so are less likely to remain on the fabric after the end of the rinse cycle.

We have now devised a class of fabric softening composition which is based on quaternary ammonium fabric softening surfactants, is in solid form, and can be dosed in the wash cycle but deliver its benefit in the rinse cycle. Additionally or alternatively, such compositions can also act as vehicles for delivery of other ingredients to the fabric. They can also be used as solid fabric conditioners for dosing direct into the rinse.

A wash cycle is a phase or cycle of a cleaning process in a washing machine where fabrics are treated in a wash liquor to remove soil. The wash liquor is typically, water containing (i.e. to be dosed with) one or more materials to aid soil removal. Typically, the wash liquor contains as a solution and/or dispersion, the ingredients of a conventional fabric washing product such as a powder, tablet or aqueous or non-aqueous liquid. Such products usually contribute to the electrolyte concentration at the wash liquor. The wash liquor is normally maintained at a temperature higher than ambient for at least part of the wash cycle, eg at a temperature around at least 30° C., more usually around 40° C., around 50° C. or around 60° C. Higher temperatures such as around 70° C. are also possible but are less common due to the high energy expenditure and potential resultant fabric damage. Many domestic washing machines have wash temperature settings over the range of from 30° C. to 60° C.

A rinse cycle normally agitates fabrics in a rinse liquor which is water at around ambient temperature, optionally containing a fabric conditioner in solution and/or dispersion.

The present invention is based on compositions which are solid and contain both a quaternary ammonium fabric softening material and inter alia a fatty acid and/or fatty alcohol component.

Our International patent application no. WO-A-06/050798 claims and describes a heat activated fabric treatment composition comprising:
a) at least 1% by weight of one or more quaternary ammonium fabric softening materials,
b) at least 1% by weight of a non-ionic surfactant, such that components a) and b) comprise at least 30% by weight of the composition,
c) at least 20% by weight of a fatty component selected from fatty acids having a melting point of at least 40° C., fatty alcohols having a melting point of at least 40° C. and mixtures thereof,
d) from 5 to 30% by weight water.

The latter composition is designed to be delivered as a liquid during the heating cycle of a tumble dryer and to be delivered from a dispensing device.

### DEFINITION OF THE INVENTION

The present invention is based on a number of utilisations and applications of a solid fabric treatment composition (hereinafter called a “composition of the invention”), that comprises:

(a) one or more quaternary ammonium fabric softening materials; and
(b) a fatty component selected from fatty acids, fatty alcohols and mixtures thereof;
this composition of the invention, its manufacture, use in, and methods of conditioning fabrics representing the present invention in its broadest expression.

Thus, a first aspect of the present invention provides a method of conditioning fabrics, the method comprising dosing a solid fabric treatment composition comprising a composition of the invention into a wash cycle of a washing machine, allowing the wash cycle to be completed and then performing a rinse cycle in the washing machine.

A second aspect of the present invention provides a method of preparing a composition of the invention, the method comprising forming a melt of the mixture of the quaternary ammonium fabric softening material(s), the fatty component, preferably at a temperature of 50° C. to 150° C., more preferably from 60° C. to 140° C., still more preferably from 80° C. to 130° C., most preferably from 85° C. to 100° C. of the quaternary ammonium fabric softening material(s), and any other optional material to be incorporated therewith, optionally with mixing, allowing or causing the melt to cool.

A third aspect of the present invention provides use of a composition of the invention in the manufacture of a product for dosing into a wash cycle of a washing machine in order to provide a fabric softening benefit during a subsequent rinse cycle.

A fourth aspect of the present invention provides a method of conditioning fabrics, the method comprising dosing a composition of the invention into a rinse cycle of a washing machine.

A fifth aspect of the present invention provides use of a composition of the invention for the manufacture of a product for dosing into the rinse cycle of a washing machine in order to provide a fabric softening benefit.

Various classes of composition of the invention embody particularly advantageous benefits.

Thus, for example, a sixth aspect of the present invention provides a composition of the present invention which comprises less than 5% by weight of water.

A seventh aspect of the present invention provides a composition of the invention which further comprises at least one additional material selected from anionic surfactants, non-polymeric water soluble builders and water soluble non-builder inorganic salts.

### DETAILED DESCRIPTION OF THE INVENTION

In the context of a composition of the present invention, the term “solid” preferably refers to a hard or soft solid material that does not flow or does not visibly deform when observed after being filled as a melt into a 250 ml glass laboratory beaker to a level which is half of the internal height of beaker, then cooled to and maintained at 25° C., the beaker then being fixed at a tilt angle 45° to the horizontal, the observation being made 5 minutes after moment of first tilting.

Compositions of the invention can be dosed into the wash cycle of an automatic washing machine because the quaternary ammonium fabric softening materials are not released into the wash liquor owing to high electrolyte concentration of wash liquors. Instead, the compositions tend to remain in contact with the wash load, e.g. adhering to the fabrics or, by virtue of their density and/or size, at least partly remaining in the drum of the end of the wash cycle. In the low electrolyte concentration of the rinse cycle, the compositions then break down to release the quaternary ammonium component which then can deliver its benefit to the fabric by virtue of being in the form of a solution or dispersion, e.g. in a lamellar gel phase.

Compositions of the invention can also be dosed direct into the rinse cycle/rinse liquor. As solid ingredients, they are far less messy than conventional liquid fabric conditioners.

Compositions according to the invention which contain less than 5 wt % of water are advantageous in avoiding deleterious interactions with fabric wash composition components which they may contact during storage. Thus, they are especially advantageous when the composition further contains one or more water sensitive ingredients such as enzymes and bleach systems or bleach system components.

Compositions according to the invention which contain at least one ingredient selected from anionic surfactants, non-polymeric water soluble builders and non-builder inorganic water soluble compounds can be dosed into the wash cycle and provide sufficient effective electrolyte to inhibit release of the fabric conditioning components until the rinse cycle.

### Product Form

The compositions of the invention may be provided in several different forms. They may be provided as particles or pellets of the composition. Particles of the composition of the invention may also be formed into granules also containing particles of other materials. To form such granules, the particles may for example be mixed with other materials to form a slurry which is spray dried. The granules may instead be formed by a mechanical mixing and granulation process, e.g. as disclosed in any of EP-A-0 367 339, EP-A-0 390 251 or EP-A-420 317. In these processes, solid particles are mixed with other components including surfactant and a liquid component, to achieve a deformable state, whereby the mechanical mixing action achieves deformation and densification of the granules which are subsequently dried.

Particles, pellets or granules of compositions according to the present invention may also be dry mixed with one or more other materials, e.g. in powder or in granular form.

Compositions of the present invention may also be provided in tablet form. i.e. as an entire tablet or as a discrete part thereof, e.g. a layer or inclusion. When present as all or part of a tablet, the compositions of the invention may be present as a unitary body or as compressed particles or granules thereof, optionally dry mixed with one or more other materials. When a tablet comprises two or more discrete regions comprising one or other ingredients, particles or granules of compositions according to the invention may be admixed with such ingredient or ingredients but only in one or some (but not all) of those discrete regions. The unitary solid may also be body of material cast inside a porous dosing device or a dosing device provided with one or more exit holes.

Thus, particles, pellets or granules may, inter alia, be in admixture with the components of a conventional laundry wash product.

Compositions of the invention may also be used to encapsulate other ingredients. In other words, one or more other ingredients form part of a shell which is surrounded by a core comprising or consisting of compositions according to the invention.

Thus, to summarise, compositions according to the present invention may be provided alone as particles or pellets or in any other solid form or may be employed in combination with one or more other materials in granules and/or particles or pellets of compositions according to the invention may be dry mixed with particles or granules comprising one or more other materials and/or may be present as a unitary body forming all or part of a tablet. Any of these product forms may also be located inside a dosing device such as described above.

Compositions according to the present invention may also contain one or other materials intimately mixed in the quaternary ammonium fabric softening material(s) and the fatty component. Suitable such other materials which may be intimately mixed in this way are preferably one or more of those which are not incompatible with the quaternary ammonium and fatty material(s), for example silicone oil, mineral oil, and perfume, and mixtures thereof.

Compositions according to the present invention preferably contain from 15% to 70%, more preferably from 25% to 60%, most preferably from 35% to 50% by weight of the quaternary ammonium fabric softening material(s). Preferably, they contain from 30% to 85%, more preferably from 45% to 80%, most preferably from 60% to 75% by weight of the fatty component. Although compositions according to the present invention may be substantially devoid of any other material(s), they may for example contain from 0.001% to 60%, preferably from 5% to 30% by weight of such other material(s). In this content, a composition according to the invention means a solid consisting of the quaternary ammonium fabric softening material(s), the fatty component and optionally, one or more other materials intimately admixed therewith and does not include any other materials, dry mixed therewith, included as a separate particulate in any granule also containing a composition of the invention, or any other material present in a different part of a tablet containing the composition of the invention.

### Manufacturing Processes

Compositions according to the present invention are preferably made by forming a melt of the mixture of the quaternary ammonium fabric softening material(s) and the fatty component, preferably at a temperature made by forming a melt, preferably at a temperature at from 50° C. to 150° C., preferably from 60° C. to 140° C., preferably from 70° C. to 150° C., more preferably from 80° C. to 130° C., most preferably from 85° C. to 100° C. of the quaternary ammonium fabric softening material(s), any other optional material to be mixed therewith, optionally with mixing, allowing the melt to cool and if desired, forming the melt into particles or pellets prior to any optional subsequent process such as granulation, dry mixing, tabletting etc.

### a) Quaternary Ammonium Fabric Softening Materials

The composition comprises at least one quaternary ammonium fabric softening material. Preferably, the molar ratio of this component to that of the fatty component, especially when at least 75%, preferably at 85%, more preferably at least 90% by weight and most preferably substantially all of the fatty component consists of one or more fatty alcohols is from 10:1 to 1:5, more preferably from 5:1 to 1:3, for example from 5:1 to 1:1 and most preferably from 4:1 to 2:1.

A first group of cationic fabric softening compounds which can be used is represented by formula (I):

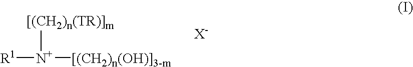

wherein each R is independently selected from a C₅₋₃₅ alkyl or alkenyl group, R¹ represents a C₁₋₄ alkyl, C₂₋₄ alkenyl or a C₁₋₄ hydroxyalkyl group,

### T is

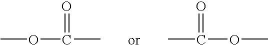

n is 0 or a number selected from 1 to 4, m is 1, 2 or 3 and denotes the number of moieties to which it relates that pend directly from the N atom, and X⁻ is an anionic group, such as halides or alkyl sulphates, e.g. chloride, methyl sulphate or ethyl sulphate.

Preferred materials of this class are di-alkenyl esters of triethanol ammonium methyl sulphate.

Commercial examples include Tetranyl AHT-1 (di-hardened oleic ester of triethanol ammonium methyl sulphate 80% active), Tetranyl AT-1(di-oleic ester of triethanol ammonium methyl sulphate 90% active), L5/90 (palm ester of triethanol ammonium methyl sulphate 90% active), all ex Kao, and Rewoquat WE15 (C₁₀-C₂₀ and C₁₆-C₁₈ unsaturated fatty acid reaction products with triethanolamine dimethyl sulphate quaternised 90% active), ex Witco Corporation and Stepantex VL85G ex Stepan.

The second group of cationic fabric softening compounds for use in the invention is represented by formula (II):

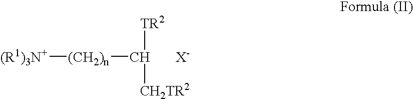

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined in Formula (I) above.

A third group of cationic fabric softening compounds for use in the invention is represented by formula (III):

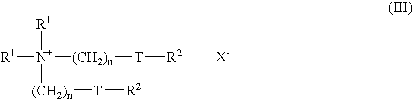

wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined in Formulae (I) or (II) above.

A fourth group of cationic fabric softening compounds for use in the invention is represented by formula (IV):

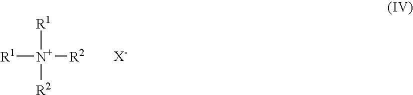

wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined in any of Formulae (I)-(III) above.

A fifth group of cationic fabric softening compositions for use in the invention is represented by Formula (V):

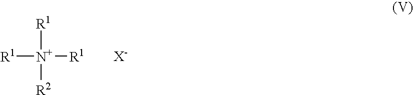

wherein each R¹ group is independently selected from C₁₋₄ alkyl, or C₂₋₄ alkenyl groups; and wherein the R² group is independently selected from C₈₋₂₈ alkyl or alkenyl groups; and X⁻ is as defined in any of Formulae (I)-(IV) above.

In any composition according to the present invention, the quaternary ammonium fabric softening material may for example be present in an amount from 15% to 70%, by weight of the composition, preferably from 25% to 60% by weight, most preferably from 35% to 50% by weight.

### (b) Fatty Component

The compositions of the present invention comprise a fatty component selected from fatty acids and fatty alcohols and mixtures thereof. The fatty component has a melting point from 50° C. to 150° C., preferably from 55° C. to 80° C. The fatty acids and alcohols have a melting point of at least 40° C., preferably at least 50° C., most preferably in the range 55 to 75° C.

Suitable fatty acids/alcohols have a saturated and/or unsaturated carbon chain having a length of from 14 to 26 carbon atoms, more preferably 12 to 22, most preferably from 12 to 20 carbon atoms. Preferably, at least 50%, more preferably at least 75%, especially at least 90% and most preferably substantially all of the fatty component is saturated and/or unsaturated fatty acid(s) and/or fatty alcohols independently having carbon chain length(s) within one of these ranges.

The fatty component is present in an amount of at least 20%, preferably at least 25%, more preferably in the range 30 to 40% of the total composition. It is preferred, although not essential, that fatty acid is present since this material may additionally act as an antistatic agent.

Optionally, both fatty acid and fatty alcohol materials are present. Generally, the amount of fatty alcohol is greater than the amount of fatty acid.

Preferred fatty acids include hardened tallow fatty acid (available under the tradename Pristerene, ex Uniqema) and hardened Palmitic acid (available under the trade name Prifrac 2960 ex Uniqema).

Preferred fatty alcohols include hardened tallow alcohol (available under the tradenames Stenol and Hydrenol, ex Cognis and Laurex CS, ex Albright and Wilson) and behenyl alcohol, a C22 chain alcohol, available as Lanette 22 (ex Henkel).

(c) Optional Other Materials for Intimate Admixture with the Quaternary Ammonium And Fatty Ingredients

### (i) Water

Depending on the aspect of the invention, the compositions of the invention preferably contain less than 5% by weight of water and most preferably are substantially free of water. However, in some aspects of the invention, they may for example contain an amount such as from 0.001 to 50%, preferably from 0.01 to 30%, more preferably from 5 to 20% by weight of water based on the weight of the total composition.

Low amounts of water are especially advantageous where it is desired to avoid adverse interactions with other components which may be present in the composition.

For the avoidance of doubt, the water content of the composition is not to be taken as including any water intimately bound with any component of the composition such as water of crystallisation.

### (ii) Solvent

Optionally and advantageously, the compositions comprise an organic solvent. The solvent may be present to aid dissolution of the quaternary ammonium softening materials in the rinse cycle. The solvent further optimises the viscosity and flow temperature characteristics of the composition. Additionally, the solvent may act as a humectant retarding the loss of water from the composition upon storage.

Preferably the solvent is semi-polar.

Suitable solvents include any which have a flash point above the heating temperature of a tumble dryer. Ideally the solvent is also odourless.

Commercially available examples include polyols, such as glycol ethers. The most preferred solvent is dipropylene glycol.

The solvent is preferably present at a level of from 1 to 20% by weight, most preferably from 3 to 10% by weight, based on the total weight of the composition.

It is possible to replace all or part of the water with one or more solvents. In this case, a higher level of added solvent and lower level of water than described herein may be present in the composition.

(iii) Perfume

It is desirable that the compositions of the present invention also comprise one or more perfumes. Suitable perfume ingredients include those disclosed in “Perfume and Flavor Chemicals (Aroma Chemicals)”, by Steffen Arctander, published by the author in 1969, the contents of which are incorporated herein by reference. A preferred perfume is commercially available under the trade name Amazone.

Optionally, up to 40 wt %, preferably up to 30 wt %, eg up to 20 wt % of perfume (including the weight of any perfume carrier) can be incorporated in the compositions of the present invention without destabilising the composition. Such levels are significantly higher than those present in commercially available tumble dryer sheets. Accordingly, better perfume substantivity and longevity can be achieved from the present compositions than from traditional tumble dryer sheets.

Thus, it is desirable that the level of perfume (including carrier) is greater than 3 wt %, more preferably greater than 4 wt %, most preferably greater than 5 wt %, based on the total weight of the composition.

### (iv) Oils

Silicone oil, ester oil and mineral oil may be used to soften fabric and/or enhance perfume delivery in normal conditioners. These oils can be incorporated in the composition. Up to 30% oils were mixed into the composition without impairing the compositions' stability. “Silicone oils” also includes the ester oils.

### (v) Other Optional Fabric Conditioning Ingredients

Compositions of the Invention may also contain one or more optional ingredients conventionally included in fabric conditioning compositions such as pH buffering agents, colourants, antifoaming agents, antiredeposition agents, polyelectrolytes, enzymes, optical brightening agents, anti-shrinking agents, anti-wrinkle agents, anti-spotting agents, germicides, fungicides, anti-bacterial agents, lubricants, solvents, anti-corrosion agents, drape imparting agents, ironing aids and dyes.

### (vi) Wash Composition Components and Electrolytes

As stated above, particularly when compositions of the invention are for dosing into the wash cycle, one or more additional materials are preferably employed to ensure that the electrolyte concentration of the wash liquor is sufficiently high to prevent premature release of the fabric conditioning components. This may be achieved by dosing a wash composition or in any event, a composition having one or more components which are effective electrolytes, into the wash liquor, separate from the composition of the invention. Alternatively, the composition of the invention may contain other components which are effective electrolyte components or wash composition components. A non-exhaustive list of effective electrolytes comprises anionic surfactants, non-polymeric water soluble (detergency) builders and water soluble non-builder inorganic salts.

Suitable wash composition components, including effective electrolytes, as well as other effective electrolytes, will now be described. Inclusion levels of suitable wash components or other electrolytes, where mentioned in the context of a wash composition separate from a composition of the invention are by weight of that wash composition. Where any is to be employed as an additional component of a composition of the invention, inclusion levels are percentages by weight of the total composition remaining after subtraction of the weight of the quaternary ammonium fabric softening material(s) and of the weight of the fatty component (i.e. the “composition” of which the additional component is expressed as a weight percentage is to be taken as consisting of all ingredients except the quaternary ammonium fabric softening material(s) and the fatty component). The following section concerning suitable wash composition components, including effective electrolytes, as well as other effective electrolytes are to be taken as applicable to both of these situations.

In this specific context, when materials additional to the quaternary ammonium fabric softening material(s) and the fatty component are admixed therewith or granulated together therewith or are in a separate zone (e.g. layer) of a unitary solid such as a tablet, they are to be treated as part of the same composition, unless the language forbids.

Preferably, the total effective electrolyte in any composition is sufficient that when the composition is dosed at 0.1 g/litre into distilled water at 25° C., the conductivity of the resultant liquid is at least 5 mS, (milli-Siemens) preferably from 10 mS to 50 mS.

### Surfactant Compounds

When present, surfactant preferably provides from 5 to 50% by weight of the composition, more preferably from 8 or 9% by weight of the composition, e.g. up to 40% or 50% by weight. Surfactant may be anionic (soap or soap), cationic, zwitterionic, amphoteric, nonionic or a combination of these.

Anionic surfactant may be present in an amount from 0.5 to 50% by weight, preferably from 2% or 4% up to 30% or 40% by weight of the composition. Anionic surfactant represents one class of effective electrolyte for preventing premature release of fabric softening components into the wash liquor, before the rinse cycle.

Synthetic (i.e. non-soap) anionic surfactants are well known to those skilled in the art. One or a mixture of any of the following may be employed. Examples include alkylbenzene sulphonates, particularly sodium linear alkylbenzene sulphonates having an alkyl chain length of C₈-C₁₅; olefin sulphonates; alkane sulphonates; dialkyl sulphosuccinates; and fatty acid ester sulphonates.

Primary alkyl sulphate having the formula

ROSO₃⁻M⁺

in which R is an alkyl or alkenyl chain of 8 to 18 carbon atoms especially 10 to 14 carbon atoms and M⁺ is a solubilising cation, is commercially significant as an anionic surfactant. Linear alkyl benzene sulphonate of the formula

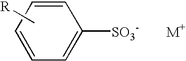

where R is linear alkyl of 8 to 15 carbon atoms and M⁺ is a solubilising cation, especially sodium, is also a commercially significant anionic surfactant.

Frequently, such linear alkyl benzene sulphonate or primary alkyl sulphate of the formula above, or a mixture thereof will be the desired anionic surfactant and may provide 75 to 100 wt % of any anionic soap surfactant in the composition.

In some forms of this invention the amount of non-soap anionic surfactant lies in a range from 5 to 20 wt % of the composition.

Soaps for use in accordance to the invention are preferably sodium soaps derived from naturally occurring fatty acids, for example, the fatty acids from coconut oil, beef tallow, sunflower or hardened rapeseed oil. Especially preferably soaps are selected from C₁₀ to C₂₀ soaps for example from C₁₆ to C₁₈ or C₁₂ soaps.

Optionally, one or more nonionic surfactant compounds may be used. Present in a composition. They include, in particular, the reaction products of compounds having a hydrophobic group and a reactive hydrogen atom, for example, aliphatic alcohols, acids, amides or alkyl phenols with alkylene oxides, especially ethylene oxide.

The nonionic surfactant may for example be present in a relevant composition at a level of from at least 5% by weight based on the total weight of the composition, preferably from 10 to 50 wt %, most preferably from 15 to 45 wt %.

The combined amount of the total amount of any non-ionic surfactant(s) and the quaternary ammonium fabric softening material(s) may be at least 20%, preferably from 10% to 70%, more preferably from 30% to 60% by weight of the total composition. Generally, the weight ratio of the quaternary ammonium fabric softening material(s) to the total weight of any nonionic surfactant(s) is within the range from 2:1 to 1:100, preferably from 3:2 to 1:75, more preferably from 1:1 to 1:20, e.g. 2:3 to 1:5.

Some preferred nonionic surfactants are solid at ambient temperature so that they contribute to the physical integrity of the solid composition.

Suitable nonionic surfactants include addition products of ethylene oxide and/or propylene oxide with fatty alcohols, fatty acids and fatty amines.

For example, appropriate nonionic surfactants may comprise an average degree of alkoxylation of from 8 to 40 alkoxy units per molecule, more preferably 10 to 30, even more preferably 11 to 25, e.g. 12 to 22 alkoxy units. Some preferred nonionic surfactants have an HLB within the range 8 to 20, more preferably 10 to 20.

Some such suitable nonionic surfactants are substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched
chain alkenyl-substituted phenolic hydrocarbyl groups; the hydrocarbyl groups having a chain length of from 8 to about 25, preferably 10 to 20, e.g. 12 to 18 carbon atoms with coco and tallow or chain composition being most preferred.

In the general formula for the ethoxylated nonionic surfactant, Y is typically:

—O—,—C(O)O—,—C(O)N(R)— or —C(O)N(R)R—

in which R has the meaning given above or can be hydrogen; and Z is preferably from 8 to 40, more preferably from 10 to 30, most preferably from 11 to 25, e.g. 12 to 22.

The degree of alkoxylation, Z denotes the average number of alkoxy groups per molecule.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol.

In some fabric washing tablets of this invention, the amount of nonionic surfactant lies in a range from 4 to 40%, better 4 or 5 to 30% by weight of the whole tablet.

Another suitable class of nonionic surfactants can comprise a polyol based surfactant such as sucrose mono-, di- and poly-esters. Examples of suitable sucrose esters include sucrose monooleates, sucrose monostearate or mixture thereof, poly glycerols, alkyl polyglucosides such as coco or stearyl monoglucosides and stearyl triglucoside and alkyl polyglycerols.

### Detergency Builder

In principle, any composition may typically contain from 5 to 80%, more usually 15 to 60% by weight of detergency builder. This may be provided wholly by water soluble materials, or may be provided in large part or even entirely by water-insoluble material with water-softening properties. Water-insoluble detergency builder may be present as 5 to 80 wt %, better 5 to 60 wt % of the composition.

Alkali metal aluminosilicates are strongly favoured as environmentally acceptable water-insoluble builders for fabric washing. Alkali metal (preferably sodium) aluminosilicates may be either crystalline or amorphous or mixtures thereof, having the general formula:

0.8-1.5Na₂O.Al₂O₃. 0.8-6SiO₂.xH₂O

These materials contain some bound water (indicated as □xH2O□) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange detergency builders are described, for example, in GB-A-1 429 143. The preferred sodium aluminosilicates of this type are the well known commercially available zeolites A and X, the novel zeolite P described and claimed in EP-A-384 070 and mixtures thereof.

Conceivably a water-insoluble detergency builder could be a layered sodium silicate as described in U.S. Pat. No. 4,664,839.

NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used.

Water-soluble phosphorous-containing inorganic detergency builders, include the alkali-metal orthophosphates, metaphosphates, pyrophosphates and polyphosphates. Specific examples of inorganic phosphate builders include sodium and potassium tripolyphosphates, orthophosphates and hexametaphosphates.

Non-phosphorous water-soluble builders may be organic or inorganic. Inorganic builders that may be present include alkali metal (generally sodium) carbonate; while organic builders include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

Suitable polymeric detergency builders, may comprise polycarboxylate polymers, more especially polyacrylates and acrylic/maleic copolymers which can function as builders and also inhibit unwanted deposition onto fabric from the wash liquor.

### Bleach Systems

Compositions may optionally contain a bleach system. Bleach system means one or more bleaches or any combination of materials which interact to exert their bleaching action. In a tablet, at least part of the bleach system may be ain a region separate from any sensitive components. Any bleach system may comprise one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate or sodium percarbonate; and perbenzoic acid precursors. The quaternary ammonium and phosphonium bleach activators disclosed in U.S. Pat. No. 4,751,015 and U.S. Pat. No. 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

As indicated above, if a bleach is present and is a water-soluble inorganic peroxygen bleach, the amount may well be from 10% to 25% by weight of the composition.

Additionally or alternatively, the bleach system may comprise a catalyst of bleaching by atmospheric oxygen, e.g. in the form of an organic ligand complexed with a metal ion such as iron or manganese.

Other Wash Composition Ingredients P Compositions may also contain (preferably in the second region) one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N.V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

Compositions may also contain (preferably in the second region) a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material may advantageously be included if primarily intended for use in front-loading drum-type automatic washing machines. Suitable antifoam materials are usually in granular form, such as those described in EP-A-266 863. Such antifoam granules typically comprise a mixture of silicone oil, petroleum jelly, hydrophobic silica and alkyl phosphate as antifoam active material, absorbed onto a porous absorbed water-soluble carbonate-based inorganic carrier material. Antifoam granules may be present in an amount up to 5% by weight of the composition.

It may also be desirable for a composition to includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in the case of manufacture of a material which is compacted into tablets.

A tablet for fabric washing will generally not contain more than 15 wt % silicate. A tablet for machine dishwashing will often contain more than 20 wt % silicate. Preferably the silicate is present in the second region of the tablet.

Further ingredients which can optionally be employed include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

### Further Non-Builder Water Soluble Inorganic Compounds

Compositions may also include one or more water soluble inorganic electrolytes water soluble such as alkali metal (e.g. sodium or potassium) or alkaline earth metal salts such as sulphates, halides (e.g. chlorides), nitrates etc. These may for example be included at levels from 0.001% to 15% by weight, such as from 0.1% to 10% by weight of the composition.

### EXAMPLES

The invention will now be illustrated by the following non-limiting examples. Further modifications within the scope of the invention will be apparent to the person skilled in the art.

### Example 1

| Ingredients | Weight percentage |
|---|---|
| Cetyl alcohol | 65 |
| Cetyltrimethylammonium Bromide | 35 |

Cetyl alcohol and cetyltrimethylammonium bromide were mixed at ambient temperature. The mix was then heated in a water bath at 90° C. until an isotropic solution was formed. The melts was then cooled to room temperature and the solid conditioner was obtained. A grinder was used to grind the solid to powder. Use of a CO₂ blanket is advised to avoid the risk of dust explosions.

### Example 2

| Ingredients | Weight percentage |
|---|---|
| Cetyl alcohol | 70 |
| Cetyltrimethylammonium Chloride | 20 |
| Arquad 2HT (DHTDMAC) | 10 |

Cetyl alcohol, cetyltrimethylammonium chloride and Arquad 2HT were mixed at ambient temperature. The mix was then heated in a water bath at 90° C. until an isotropic solution was formed. The melts was then cooled to room temperature and the solid conditioner was obtained. A grinder was used to grind the solid to powder.

### Example 3

| Ingredients | Weight percentage |
|---|---|
| Cetyl alcohol | 60 |
| Cetyltrimethylammonium Chloride | 15 |
| Arquad 2HT (DHTDMAC) | 8 |
| Perfume (Takasago EPL PLB865/3) | 10 |
| Silicone oil (200cs 50cs) | 3 |
| Mineral oil | 4 |

Cetyl alcohol, cetyltrimethylammonium chloride and Arquad 2HT were mixed at ambient temperature. The mix was then heated in a water bath at 90° C. until an isotropic solution was formed. The melts was then cooled. Perfume, silicone oil and mineral oil were added to the molten phase with stirring at 75° C. before the melts solidified. A solid mixture was obtained on cooling to room temperature. A grinder was used to grind the solid to powder. It was found that cooling the solid to sub zero temperature helped to increase its hardness and therefore making the grinding process easier.

### Example 4

| Ingredients | Weight percentage |
|---|---|
| Skip (Persil) Bio detergent | 95 |
| Cetearyl alcohol (Laurex CS) | 0.5 |
| Di(hydrogenated tallow) | 4.2 |
| dimethylammonium chloride (Arquad HC) | |
| Perfume | 0.3 |

The cetearyl alcohol and di(hydrogenated tallow) dimethylammonium chloride were mixed at ambient temperature. The mix was then heated in a water bath at 90° C. until an isotropic solution was formed. The melts was then cooled. The perfume was added to the molten phase with stirring at 75° C. before the melts solidified. A solid fabric treatment composition was obtained on cooling to room temperature. A grinder was used to grind the composition to a powder.

The powder was then separated into three size ranges of 600-850 microns, 425-600 microns and 75-425 microns using appropriately sized sieves.

The powder was then mixed with Skip (Persil) Bio detergent when both constituents were in the form of powders thereby to form a solid fabric cleansing and treatment composition. The solid fabric cleansing and treatment composition was then dosed into a washing machine at the beginning of the washing cycle.

It was observed that the softening performance of the solid fabric treatment composition improved as the particle size decreased from 600-850 microns, through 425-600 microns to 75-425 microns.

### Example 5

| Ingredients | Weight percentage |
|---|---|
| Skip (Persil) Bio detergent | 94.4 |
| Cetearyl alcohol (Laurex CS) | 1.2 |
| Difettacycloxiethyl hydroxyethyl methyl | 4.2 |
| ammonium methosulfat (Praepagen TQL) | |
| Perfume | 0.2 |

The solid fabric treatment composition and solid fabric cleansing and treatment composition were prepared in the same manner as set forth hereinabove in example 4. The solid fabric cleansing and treatment composition was tested in identical fashion as given in example 4 with the same results.

1. A method of conditioning fabrics, the method comprising dosing a solid fabric treatment composition comprising:
(a) one or more quaternary ammonium fabric softening materials;
(b) a fatty component selected from fatty acids, fatty alcohols and mixtures thereof; and
(c) less than 10% by weight of the solid fabric treatment composition of water, solvent or a mixture thereof;
into a wash or a rinse cycle of a washing machine, allowing the wash cycle to be completed and then performing a rinse cycle in the washing machine,
wherein the fatty component has a melting point from 55° C. to 80° C.; and
wherein the sum of (a) and (b) is at least 80% by weight of the solid fabric treatment composition.

2. A method according to claim 1, wherein the molar ratio of component (a) to component (b) is from 4:1 to 2:1.

3. A method according to claim 1, wherein the fatty material consists of or comprises one or more materials which are fatty alcohols and/or fatty acids which fatty alcohols/fatty acids have a saturated or unsaturated carbon chain independently having from 12 to 20 carbon atoms.

4. A method according to claim 1, wherein the solid fabric treatment composition is mixed with a solid fabric cleansing composition whilst both compositions are in the solid phase.

5. A method according to claim 4 wherein the solid fabric cleansing composition comprises at least one material selected from anionic surfactants, non-ionic surfactants, non-polymeric water soluble builders and water soluble non-builder inorganic salts.

6. A method according to claim 1 wherein the solid fabric treatment and/or the solid fabric cleansing compositions are in the form of powders.

7. A method according to claim 1 wherein the solid fabric treatment composition with or without the solid fabric cleansing composition is dosed in the absence of any form of packaging.

8. A method according to claim 7 wherein packaging includes pouches, pillows, sachets, envelopes, bags, wrappers and any other containers.

9. A method of preparing a composition according to claim 1, the method comprising forming a melt of the mixture of the quaternary ammonium fabric softening material(s), the fatty component, at a temperature from 85° C. to 100° C., and any other optional material to be incorporated therewith, optionally with mixing, allowing or causing the melt to cool.

10. A solid fabric treatment composition comprising:
(a) one or more quaternary ammonium fabric softening materials; and
(b) a fatty component selected from fatty acids, fatty alcohols and mixtures thereof; and
(c) less than 10% by weight of the solid fabric treatment composition of water, solvent or a mixture thereof;
wherein the fatty component has a melting point from 55° C. to 80° C.; and
wherein the sum of (a) and (b) is at least 80% by weight of the solid fabric treatment composition.

11. A composition according to claim 10, wherein the molar ratio of component (a) to component (b) is from 4:1 to 2:1.

12. A composition according to claim 10, wherein the fatty material consists of or comprises one or more materials which are fatty alcohols and/or fatty acids which fatty alcohols/fatty acids have a saturated carbon chain having from 12 to 20 carbon atoms.

13. A composition according to claim 10, wherein the solid fabric treatment composition is in the form of a powder.

14. A solid fabric cleansing and treatment composition consisting only of:
(a) the solid fabric treatment composition of claim 10; and
(b) a solid fabric cleansing composition;
wherein the composition of (a) and (b) are mixed together whilst in the solid phase.

15. A solid fabric cleansing and treatment composition according to claim 14 wherein the solid fabric cleansing composition comprises at least one material selected from anionic surfactants, non-ionic surfactants, non-polymeric water soluble builders and water soluble non-builder inorganic salts.

16. A solid fabric cleansing and treatment composition according to claim 14 in the form of a powder.
